(19) United States
(12) Patent Application Publication
(10) Pub. No.: US 2003/0026940 A1
(43) Pub. Date: Feb. 6, 2003

(54) Decorative door cover

(76) Inventor: Jessie H. Bullock, Durham, NC (US)

Correspondence Address: OLIVE & OLIVE, P.A., 500 MEMORIAL STREET, PO BOX 2049, DURHAM, NC, 27702, US

(21) Appl. No.: 10/210,467

(22) Filed: Jul. 31, 2002

Related U.S. Application Data
(60) Provisional application No. 60/309,122, filed on Jul. 31, 2001.

(51) Int. Cl. B32B 3/06

(52) U.S. Cl. 428/99

(57) ABSTRACT

A decorative door cover can be manufactured in a variety of sizes and themes to fit any door and provides an attractive, easy to use cover that can be used over and over again. The reusable decorative door cover is composed of a sheet of material sized to cover the face of the door to be decorated and to extend onto or around the sides thereof. The sheet has punch-outs that allow the door cover to pass over deadbolts, door locks, doorknobs and door hinges without removing the door or the hardware of the door. Elastic edging extends across the top and the bottom edges of the decorative door cover, and pockets formed in the four corners of the sheet fit over the four corners of the door. The elasticized edging, pockets, and non-elasticized sides of the sheet securely hold the door cover in place.

### FIELD OF THE INVENTION

The present invention is based on provisional patent application No. 60/309,122 entitled “DOOR DECORATION COVER SYSTEM”, filed Jul. 31, 2001 by applicant of the present non-provisional patent application.

### BACKGROUND OF THE INVENTION

a) Field of the Invention

The present invention is directed to door coverings, and specifically to decorative door covers adapted for manufacture in a variety of sizes and themes to fit any sized door and provide an attractive, inexpensive and easy to use cover that can be used over and over again.

b) Description of Related Art

It has become a widespread custom to decorate the front door of a home, apartment, store, or other building. Such door coverings often commemorate a season of the year, religious season, or holiday; mark special events such as birthdays, anniversaries, graduations, bridal or baby showers, childbirth; or indicate support for schools, sports teams, and other groups or institutions. Door coverings also may simply be used for decorative purposes unrelated to particular events or themes.

Heretofore, various means of attaching paper decorations or objects to a door have been employed, such as adhesive tape, hook and loop fasteners, glue, staples, thumbtacks, screws, and nails. When the decorations are removed and the means of securement is removed, the appearance of the door often is marred by unsightly tape or glue remnants or by staple, thumbtack, screw, or nail holes.

In addition to marring the door, conventional decorative techniques require considerable time on the part of one or more persons both to conceive and to affix the desired door decorations. Further, when removal of the decoration begins, much care and time must be expended to remove the decorations carefully so that they can be saved for future use. Otherwise, the decorative door covering may be destroyed and not be useable again.

Others have attempted to overcome the aforementioned problems. For example, U.S. Pat. No. 5,922,437, issued Jul. 13, 1999 to Monta Sue Bryant, discloses an adjustable fully fitted cover for household items and doors. U.S. Pat. No. 5,123,223, issued Jun. 23, 1992 to Justine D. Makarevich, et al, discloses a decorative sheet, preferably cloth or paper, that covers all or a substantial portion of a face of the door; and attachment means at the corners of the sheet for attaching it to the door. U.S. Pat. No. 5,946,869, issued Sep. 7, 1999 to Benson Zinbarg, discloses a decorative garage door assembly flexible panel assembly.

Nonetheless, there remains a need in the art for a decorative door cover that is simple and inexpensive to manufacture, that can be manufactured to fit a variety of door sizes, and that is easy to apply and to remove. One object of the present invention is to meet this need.

Another object of the present invention is to provide a decorative door cover that allows for closing and opening of the door, by accommodating for the hinges, dead bolts, doorknobs, and door locks.

Another object of the present invention is to provide a decorative door cover that may be removed after use, washed if necessary, and easily stored for use at a later date.

Another object of the present invention is to provide a decorative door cover that is reversible.

A further object of the present invention is to provide a decorative door cover that is weather resistant and that is firmly held in place and can withstand winds without being blown off the door.

### SUMMARY OF THE INVENTION

The present invention provides a decorative door cover that can be manufactured in a variety of sizes and themes to fit any door and provide an attractive, easy to use cover that can be used over and over again. The reusable decorative door cover is composed of a sheet of material sized to cover the face of the door to be decorated and to extend onto or around the sides thereof. The sheet has punch-outs, holes, or removable coverings in appropriate areas so that when they are in an open or removed position, the door cover can pass over and around any deadbolts, door locks, doorknobs, peepholes, door hinges and the like without removing the door or the hardware of the door.

Elastic edging extends across the top and the bottom edges of the decorative door cover, and pockets are formed in the top and bottom of the sheet fit over the top and bottom horizontal edges of the door. The elasticized edging, pockets, and non-elasticized sides of the sheet securely hold the door cover in place. The sheet optionally can be further secured by passing through it a hook, nail, or the like that is fixedly mounted to the door, or by passing through it a small string, wire or the like for attachment to a pre-existing object, such as a door knocker, that is fixedly mounted to the door. The hook, nail, string or wire then can be used to support a wreath or other object on top of the decorative door cover.

The present invention and its features and advantages will be more fully understood, and further features and advantages will become apparent, when reference is made to the following detailed description of the invention, including the drawings, and the claims.

### BRIEF DESCRIPTION OF THE DRAWINGS

FIG. 1 is a pictorial view of a standard door having a decorative cover, illustrative of the present invention, installed thereon.

FIG. 2 is a front plan view of the decorative cover of the present invention prior to being installed on a door.

FIG. 3 is an enlarged, plan view of the decorative cover of the present invention better illustrating the cutouts for the door hinges, door locks and doorknobs.

### DESCRIPTION OF AN EMBODIMENT

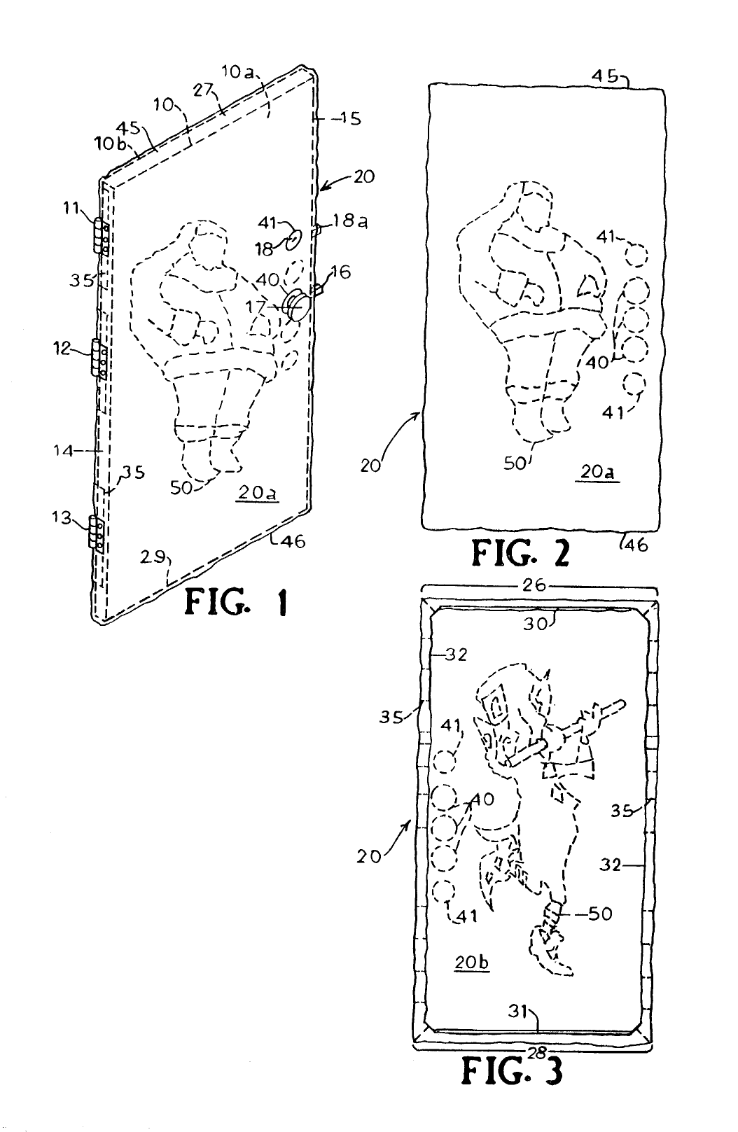

Referring to the drawings in detail, wherein like numerals indicate like elements, there is shown in FIGS. 1 through 3, an embodiment of the present invention decorative door cover 20 adapted to fit on a standard door 10 which has front and back door surfaces 10a, 10b respectively. Door 10 is typically rectangular in shape and has hinges 11, 12, 13 attached at vertical longitudinal edge 14 of door 10 which hinges standard door 10 for swinging movement about a vertical axis adjacent to the vertical longitudinal edge 14 of door 10. The opposite longitudinal edge 15 of door 10 has a latch bolt 16 extending outward therefrom that is operated by a door handle or door knob 17 mounted in door 10 in a conventional manner. Door 10 also has a deadbolt lock 18 mounted therein and extending from the front to the rear sides of door 10 with a deadbolt latch 18a extending outward from opposite longitudinal edge 15 of door 10.

Decorative door cover 20 is preferably made from a thin, yet durable cloth or plastic material. A decorative element 50 (for example a Santa or Leprechaun as shown) is printed on the material if desired for the appropriate holiday or other decorative need. Door cover 20 has a top pocket 26 and bottom pocket 28 formed therein at opposed top and bottom ends 45, 46 of door cover 20. The pockets 26, 28 further have a corresponding elasticized seam 30, 31 running respectively horizontally across the edge of top pocket 26 and bottom pocket 28, connecting the corners of each pocket and which elastic acts as a transverse compression means to tighten door cover 20 onto door top horizontal edge 27 and door bottom horizontal edge 29. Being elastic is meant any stretchy material that can be sewn into the cloth or plastic material to act to compress the pocket around the door edge. Such stretchy material is readily available in the art.

Door cover 20 preferably is cut from a sheet of material in a die cutting operation so that when the edges cut out from each corner are stitched together using conventional techniques well known to those skilled in the art of sewing, they form top pocket 26, and bottom pocket 28. A series of perforations 35 are preformed in door cover 20 along the outside and inside edges. Pre-formed perforations 35 are designed to be punched out in order to accommodate door hinges 11, 12 and 13, latch bolt 16, and deadbolt latch 18a.

Further, door cover 20 preferably has a second and third series of perforations 40, 41 formed along the opposite longitudinal front surface 10a opposite to door hinges 11, 12 and 13. These multiple perforations are designed to accommodate the different heights at which door hardware may be mounted on different doors. Perforations 40 when designed to create a hole that will fit over a standard doorknob are circular in nature, although it will be evident to those skilled in the art that perforations 40 can be made in other shapes as appropriate for the fixture over which they are to fit. Selected perforations 40 can be punched out from door cover 20 to allow door cover 20 to pass over door 20 and to fit over doorknob 17. Perforations 41 are intended to fit over deadbolt locks. Again, the shape of perforations 41 typically is expected to be circular but could be made in other shapes appropriate to the lock over which the door cover is expected to fit. As depicted in FIG. 2, a selected circular perforation 41 can be punched out to accommodate the location of the deadbolt lock 18. Fitting door cover 20 around the door hardware in this manner assists in holding door cover 20 securely on door 10.

All perforated material that is removed can be retained for possible future replacement as needed if the reverse side of door cover 20 is desired to be used or if placement on a different door is desired. These punch-outs could be replaced using any convenient means such as hook and loop fasteners, tape, elastic, glue or the like.

It will be clear to those skilled in the art that any other punch-outs may be included as desired. It also will be clear to those skilled in the art that the door cover could be supplied with holes already prepared for commonly found door hardware rather than with perforations. In such cases, coverings for the holes can be supplied. Alternatively, perforations 40 can extend only partially around the area to be opened, in effect creating a hinge so that the area encompassed by perforations 40 remains attached to door cover 20 even when opened to allow passage of door knob 17. Other perforations intended to facilitate punching out areas to accommodate door hardware can be similarly treated.

Non-elasticized edges 32 of door cover 20 preferably wrap around the vertical edges 14 and 15 of door 10 although they can be less deep and extend only partially onto the vertical edges 14 and 15 of door 10. When door 10 is closed, these non-elasticized edges 32 aid in holding door cover 20 and help keep wind and rain from getting underneath door cover 20.

Door cover 20 can be removed by pulling either of top or bottom ends 45, 46 off of door 10 when desired and then lifting the remainder of door cover 20 from the door. Door cover 20 can be washed prior to being put away. Once any desired washing and drying has been completed, door cover 20 can be folded and stored for future use.

As previously mentioned, door cover 20 may be decorated on both sides, thus offering a reversible, two sided, switchable door cover 20. The decoration may consist only of color applied to door cover 20 or, as illustrated, may include a decorative element 50. When it is desired to change the appearance of door cover 20, the user need only unfold door cover 20, turn door cover 20 over, insert previously removed punched out perforations, if necessary, and then remove new perforations as needed for fitting over the door knob, deadbolt lock, and door lock. The front and back surfaces 20a, 20b of door cover 20 may be plain or solid in color or may have any of a variety of artful scenes, decorations, or attractive patterns imprinted thereon for a holiday, special occasion, or other purpose.

It is anticipated that door cover 20 could be made from a stretchable material and would thus provide an even better snug fit on door 10. Also, while not shown, should the user wish to hang a wreath or the like on the front surface of cover 20 and door 10, a tiny hole can be made in cover 20 at the desired location and a small wire, string, etc., can be passed through and attached to the door in any suitable manner. Many doors have a doorknocker on the front surface and such would provide an easy attachment means. Alternatively, a hook or nail or the like can be affixed to the door and passed through a hole in door cover 20. Suitable perforations can, if desired, be provided in door cover 20 for this purpose. The use of these alternatives would further secure cover 20 to the door in case of high winds.

The above description of an embodiment of the invention sets forth the best mode contemplated by the inventor for carrying out the invention at the time of filing this application and is provided by way of example and not as a limitation. Accordingly, various modifications and variations obvious to a person of ordinary skill in the art to which it pertains are deemed to lie within the scope and spirit of the invention as set forth in the following claims.

What is claimed is:

1. A decorative door cover for a door, the door being generally rectangular and having opposed front and back surfaces; top and bottom horizontal edges; vertical longitudinal edge; opposite vertical longitudinal edge; means for supporting said door for swinging movement about an axis adjacent to the vertical longitudinal edge of said door and means for opening, closing and locking said door said decorative door cover comprising:
(a) a generally rectangular sheet which completely covers the front surface, edges and a portion of the back surface of the door adjacent top and bottom horizontal edges;
(b) a top pocket and a bottom pocket for securing the sheet across the top and bottom horizontal edges of the door, each pocket having a transverse compression means for holding the pockets on the horizontal edges; and
(c) means for allowing the sheet to pass over or around the opening, closing and locking means and the door support means.

2. A decorative door cover as claimed in claim 1 wherein the transverse compression means comprises a first elastic strip extending across the edges of the top pocket and a second elastic strip extending across the edge of the bottom pocket.

3. A decorative door cover as claimed in claim 1 wherein the door cover has at least one decorative element preprinted thereon.

4. A decorative door cover as claimed in claim 3 wherein the at least one preprinted decorative element is printed on both sides of the door cover providing a reversible door cover.

5. A decorative door cover as claimed in claim 1 wherein the door cover has a finished decorative appearance on each side thereof so as to be reversible for use on either side.

6. A decorative door cover as claimed in claim 1 wherein the means for allowing the sheet to pass over or around the opening, closing and locking means comprises a series of perforated punch-out circular portions which are removable to receive the opening, closing and locking means of the door.

7. A decorative door cover as claimed in claim 1 wherein the means for allowing the sheet to pass over or around the door support means comprises a series of perforated punch-out portions of a size and shape that substantially matches the size and shape of the portion of the door support means around which it is desired to fit the decorative door cover, and which are removable.

8. A decorative door cover as claimed in claim 1 wherein a hole is made in a front of the sheet at a desired location to allow an attachment be made to the door.

9. A decorative door cover as claimed in claim 8 wherein the attachment to the door is designed to hold the sheet to the door.

10. A decorative door cover for a door, the door being generally rectangular and having opposed front and back surfaces; top and bottom horizontal edges; vertical longitudinal edge; opposite vertical longitudinal edge; means for supporting said door for swinging movement about an axis adjacent to the vertical longitudinal edge of said door and means for opening, closing and locking said door said decorative door cover comprising:
(a) a generally rectangular sheet which completely covers the front surface, at least a portion of the edges of the door;
(b) a top pocket and a bottom pocket for securing the sheet across the top and bottom horizontal edges of the door, each pocket having a transverse compression means for holding the pockets on the horizontal edges which covers a portion of the back surface of the door; and
(c) means for allowing the sheet to pass over or around the opening, closing and locking means and the door support means.

11. A decorative door cover as claimed in claim 10 wherein the transverse compression means comprises a first elastic strip extending across the edges of the top pocket and a second elastic strip extending across the edge of the bottom pocket.

12. A decorative door cover as claimed in claim 10 wherein the door cover has at least one decorative element preprinted thereon.

13. A decorative door cover as claimed in claim 12 wherein the at least one preprinted decorative element is printed on both sides of the door cover providing a reversible door cover.

14. A decorative door cover as claimed in claim 10 wherein the door cover has a finished decorative appearance on each side thereof so as to be reversible for use on either side.

15. A decorative door cover as claimed in claim 10 wherein the means for allowing the sheet to pass over or around the opening, closing and locking means comprises a series of perforated punch-out circular portions which are removable to receive the opening, closing and locking means of the door.

16. A decorative door cover as claimed in claim 10 wherein the means for allowing the sheet to pass over or around the door support means comprises a series of perforated punch-out portions of a size and shape that substantially matches the size and shape of the portion of the door support means around which it is desired to fit the decorative door cover, and which are removable.

17. A decorative door cover as claimed in claim 10 wherein a hole is made in a front of the sheet at a desired location to allow an attachment be made to the door.

18. A decorative door cover as claimed in claim 17 wherein the attachment to the door is designed to hold the sheet to the door.
